(19) United States
(12) Patent Application Publication
(10) Pub. No.: US 2026/0138509 A1
(43) Pub. Date: May 21, 2026

(54) LIFT ASSEMBLY FOR A VEHICLE SEATING ASSEMBLY

(71) Applicant: Ford Global Technologies, LLC, Dearborn, MI (US)

(72) Inventors: Edward Joseph Leonard Meszaros, Amhesrtburg (CA); Philip Skinner, Plymouth, MI (US)

(73) Assignee: Ford Global Technologies, LLC, Dearborn, MI (US)

(21) Appl. No.: 18/952,222

(22) Filed: Nov. 19, 2024

(51) Int. Cl. B60N 2/30

(52) U.S. Cl. CPC B60N 2/3065

(57) ABSTRACT

A vehicle seating assembly includes a seat base having an underside. The seat base is operably coupled to a vehicle floor and includes a forward portion and rearward portion. A lift assembly is operably coupled to the seat base. The lift assembly operates the seat base between a stowed position and a deployed position. The lift assembly includes a support bracket coupled to the rearward portion of the seat base. A lift bracket operably coupled to the support bracket, wherein the lift bracket engages with the forward portion of the seat base. A biasing member is operably coupled to the lift bracket. The biasing member is configured to selectively bias the first and second lift brackets as the seat base adjusts between the stowed position and the deployed position.

### FIELD OF THE DISCLOSURE

The present disclosure generally relates to a vehicle seating assembly, and more specifically to a lift assist and support assembly for a vehicle seating assembly.

### BACKGROUND OF THE DISCLOSURE

Vehicle seating assemblies often need to be durable to increase occupant comfort and placement. Vehicle seating assemblies also need to be compactable to provide additional uses for space within the vehicle. This may be accommodated by a lift assist and support assembly to stow the vehicle seating assembly.

### SUMMARY OF THE DISCLOSURE

According to a first aspect of the present disclosure, a vehicle seating assembly includes a seat base having an underside. The seat base is operably coupled to a vehicle floor and includes a forward portion and rearward portion. A lift assembly is operably coupled to the seat base. The lift assembly operates the seat base between a stowed position and a deployed position. The lift assembly includes a support bracket coupled to the rearward portion of the seat base. A lift bracket operably coupled to the support bracket, wherein the lift bracket engages with the forward portion of the seat base. A biasing member is operably coupled to the lift bracket. The biasing member is configured to selectively bias the first and second lift brackets as the seat base adjusts between the stowed position and the deployed position.

Embodiments of the first aspect of the present disclosure can include any one or a combination of the following features:
the lift bracket is operable between a first position when the seat base is in the stowed position and a second position when the seat base is in the deployed position;
the support member defines a front edge and a rear edge, wherein the front edge defines a receiving surface and a slot;
the lift bracket includes an elongate body having a first end and a second end, and wherein the second end of the lift bracket engages with the receiving surface when the seat base is in the deployed position;
the lift bracket includes a pivot bracket coupled to the second end, and wherein the pivot bracket defines an aperture;
the aperture of the pivot bracket and the slot of the support member align to receive a pivot pin;
the pivot pin includes a shaft having a first end and a second end, and wherein the first end of the shaft includes a head portion and the second end of the shaft defines a free end;
the pivot pin includes a shaft having a head portion and a free end, and wherein the free end of the pivot shaft is configured to extend through the slot of the support member and the aperture of the pivot bracket when the slot and the aperture are aligned;
the biasing member defines a channel positioned between the slot of the support member and the aperture of the pivot bracket such that the shaft of the pivot pin extends through the channel;
a seat base frame operably coupled to the underside of the seat base, wherein the seat base frame includes a beam assembly;
the elongate body of the lift bracket includes a top surface defining a groove, and wherein the groove is configured to engage with the beam assembly of the seat base frame; and
an open area is defined between the underside of the seat base and the vehicle floor when the seat base is in the stowed position.

According to a second aspect of the present disclosure, a vehicle seating assembly includes a seat base operable between a stowed position and a deployed position. The seat base includes a forward portion and rearward portion, and a support bracket operably coupled to the rearward portion of the seat base. The support bracket includes a receiving surface, and a lift bracket extending from the receiving surface of the support bracket. The lift bracket is operable between a first position when the seat base is in the stowed position and a second position when the seat base is in the deployed position.

Embodiments of the second aspect of the present disclosure can include any one or a combination of the following features:
a seat base frame including opposing side beams extending from opposing ends of a front beam;
the lift bracket defines a groove, and wherein the groove of the lift bracket is configured to receive at least one of the opposing side beams of the seat base frame;
the groove of the lift bracket is spaced apart from at least one of the opposing side beams of the seat base frame when the lift bracket is in the first position; and
a biasing member operably coupled to the lift bracket, wherein the biasing member engages with the support bracket to selectively bias the lift bracket between the first position when the seat base is in the stowed position and the second position when the seat base is in the deployed position.

According to a third aspect of the present disclosure, a seating assembly for a vehicle includes a seat base having an underside operably coupled to a vehicle floor. The seat base includes a forward portion and a rearward portion, a seatback operably coupled to the rearward portion of the seat base, and a lift assembly operably coupled to the seat base. The lift assembly operates the seat base between a stowed position and a deployed position, the lift assembly includes, a first side member and a second side member operably coupled to the rearward portion of the seat base on a first side and a second side, respectively, the second side opposite the first side, a first lift bracket extending from the first side member and a second lift bracket extending from the second side member, wherein the first lift bracket and the second lift bracket engage with the underside of the seat base and are configured to rotate about the first side member and the second side member, respectively, and a biasing member operably coupled to each of the first lift bracket and the second lift bracket configured to selectively bias the first and second lift brackets as the seat base adjusts between the stowed position and the deployed position.

Embodiments of the second aspect of the present disclosure can include any one or a combination of the following features:
each of the first side member and the second side member define a slot and each of the first lift bracket and the second lift bracket define an aperture, and wherein the slot and the aperture align to receive a pivot pin; and
the pivot pin includes a head portion and a free end, and wherein the head portion of the pivot pin is positioned on an external side of each of the first and second side members and the free end of the pivot pin is positioned proximate an internal side of each of the first and second side members.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is an isometric view of a vehicle seating assembly within an interior compartment of a vehicle;

FIG. 2 is a partial side perspective view of a vehicle seating assembly including a seat base rotatably coupled with a seatback and a lift assist and support assembly engaged with a seat base frame of the seat base;

FIG. 3 is a side perspective of a first side member operably coupled with a first lift bracket and a second side member operably coupled with a second lift bracket and a seat base frame engaged with the first and second lift brackets when a seat base is in a deployed position;

FIG. 4 is a side perspective view of a lift assist and support bracket of a lift assist and support assembly having a pivot bracket defining an aperture configured to receive a pivot pin and a biasing member encompassing the pivot pin;

FIG. 5 is a front elevational view of a lift assembly with a lift assist and support bracket in phantom operable between a first position and a second position;

FIG. 6 is a side perspective view of a lift assist and support assembly with a first lift bracket in phantom and a second lift bracket, each of the first and second lift brackets operably coupled to each of a first and second side member, respectively;

FIG. 7 is a side perspective view of a vehicle seating assembly including a seat base in a stowed state and a lift assist and support assembly in a first position; and

FIG. 8 is a front elevational view of a vehicle seating assembly including a seat base in a stowed state to define an open area.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

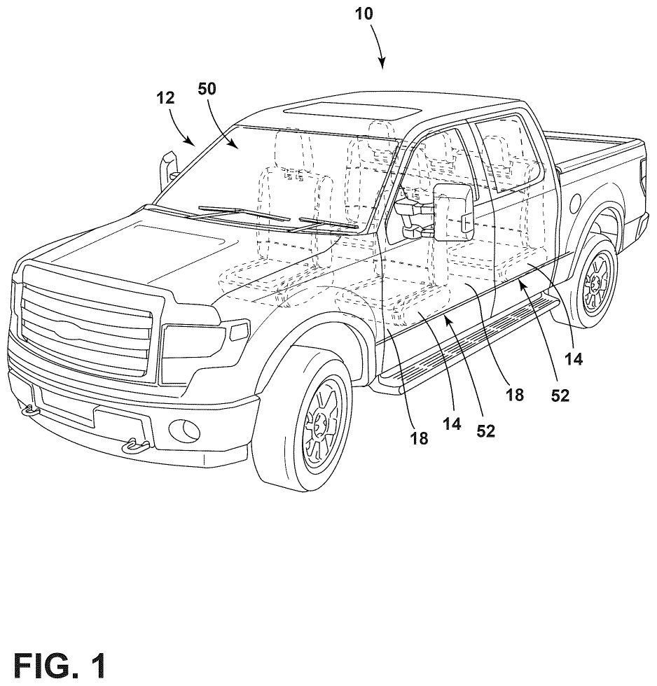

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a lift assist and support assembly for a vehicle seating assembly. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

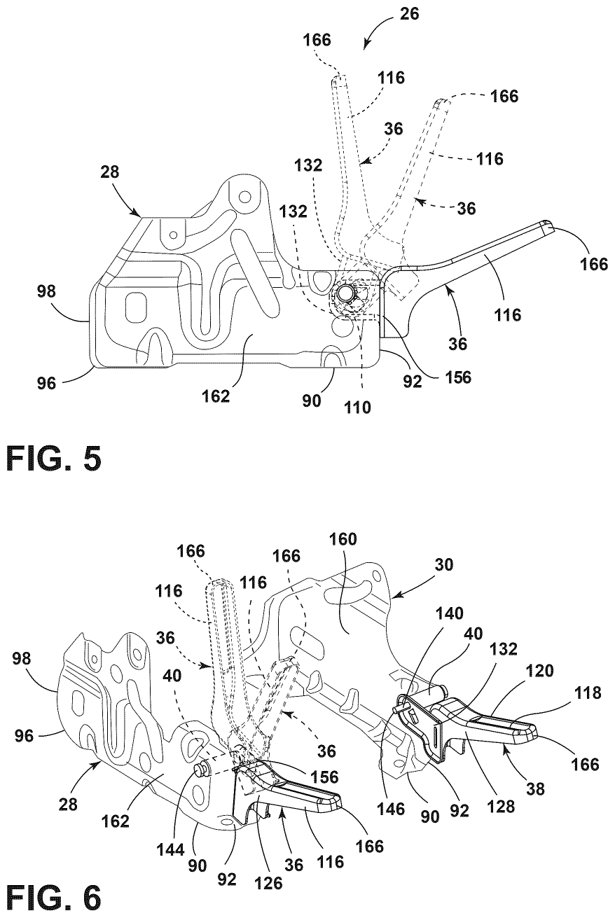

Referring to FIGS. 1-8, reference numeral 10 generally designates a seating assembly for a vehicle 12. The seating assembly 10 includes a seat base 14 having an underside 16 operably coupled to a vehicle floor 18. The seat base 14 includes a forward portion 20 and a rearward portion 22. A seatback 24 is operably coupled to the rearward portion 22 of the seat base 14. The seating assembly 10 also includes a lift assembly 26, also referred to herein as a lift assist and support assembly 26, operably coupled to the seat base 14. The lift assembly 26 operates the seat base 14 between a stowed position and a deployed position. The lift assembly 26 includes each of a first support bracket 28, otherwise referred to herein as a first side member 28 or a first support member 28, and a second support bracket 30, otherwise referred to herein as a second side member 30 or second support member 30, operably coupled to the rearward portion 22 of the seat base 14. The first support bracket 28 is operably coupled to a first lateral side 32 of the seat base 14 and the second support bracket 30 is operably coupled to a second lateral side 34 of the seat base 14. A first lift bracket 36 extends from the first support bracket 28 and a second lift bracket 38 extends from the second support bracket 30. The first and second lift brackets 36, 38 engage with the underside 16 of the seat base 14. A biasing member 40 is operably coupled to each of the first and second lift brackets 36, 38. The biasing member 40 is configured to guide the seat base 14 between the stowed position and the deployed position.

Referring now to FIG. 1, the vehicle 12 includes an interior compartment 50, which includes at least one seating assembly 52 for supporting passengers thereon. The vehicle 12 may be a sedan, a sport utility vehicle, a van, a truck, a crossover, other styles of wheeled motor vehicles, or other styles of vehicle 12. The vehicle 12 may be a manually operated vehicle (e.g., operated with a human driver), a fully autonomous vehicle (e.g., operated without a human driver), or a partially autonomous vehicle (e.g., operated with or without a human driver). Additionally, the vehicle 12 may be utilized for personal and/or commercial purposes, such as for ride-providing services (e.g., chauffeuring), transporting, and/or ride-sharing services.

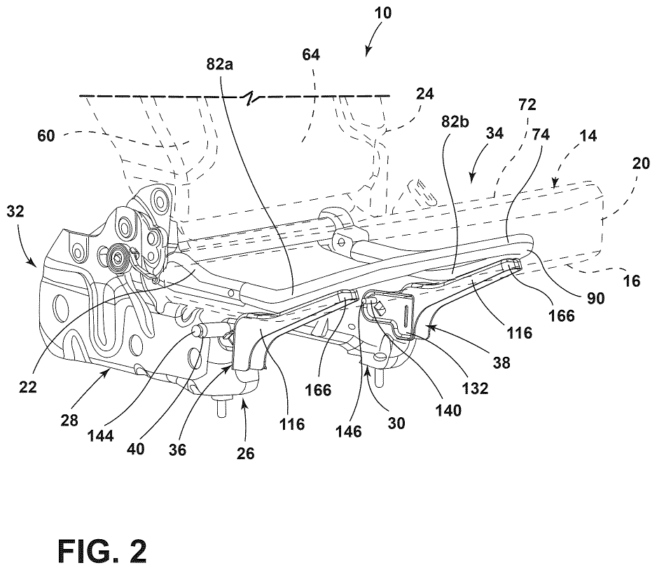

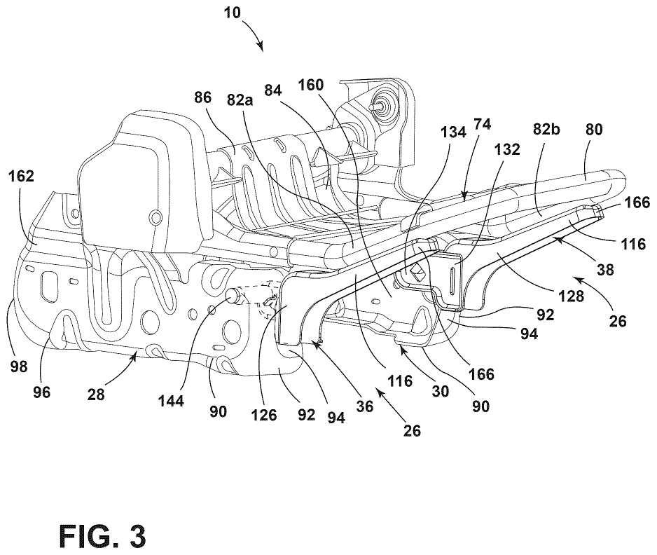

Referring still to FIG. 1, as well as FIGS. 2 and 3, the vehicle seating assembly 10 includes the seat base 14 having the forward portion 20 and the rearward portion 22, and the seatback 24 having a top portion 58 and a bottom portion 60. The rearward portion 22 of the seat base 14 is positioned proximate the bottom portion 60 of the seatback 24 such that the seatback 24 is pivotable relative to the rearward portion 22 of the seat base 14. The seatback 24 includes both an upper seatback 62 and a lower seatback 64. The vehicle seating assembly 10 includes a head restraint 66 that is disposed on the upper seatback 62. The head restraint 66 is moveable between forward and rearward positions to accommodate various sized heads of passengers, as well as different heights of passengers.

The seat base 14 includes a seat cushion assembly 72 including various cushioning properties to provide comfort while supporting the passenger. Additionally, the seat base 14 includes a seat base frame 74 that is operably coupled with the seat cushion assembly 72 and is positioned proximate the first support bracket 28 and the second support bracket 30. The seat base frame 74 includes a front beam 80 and opposing side beams 82a, 82b extending from either end of the front beam 80 to at least partially define an intermediate open area 84. A suspension assembly 86 is disposed in the intermediate open area 84 of the seat base frame 74. The suspension assembly 86 may support the seat cushion assembly 72 and is configured to withstand both the static and dynamic loads associated with seated passenger travel. Additionally, the seat base 14 may be operable between the stowed position in which the seat base 14 is folded upward so as to be positioned proximate the seatback 24 and the deployed position in which the seat base 14 is perpendicular to the seatback 24 such that a user such as a passenger may be seated on the seat base 14.

Referring still to FIGS. 2 and 3, the vehicle seating assembly 10 includes the first support bracket 28 positioned on the first lateral side 32 of the seat base 14 and the second support bracket 30 positioned on the opposing second lateral side 34 of the seat base 14. It will be noted that the first support bracket 28, or left support bracket 28, is a mirror image of the second support bracket 30, or right support bracket 30. For purposes of clarity, either one of the left or right support brackets 28, 30 may be discussed in detail herein. However, one having ordinary skill in the art will understand that the first support bracket 28 is a mirror image of the second support bracket 30, and that all features and functions of the first support bracket 28 are identical to the second support bracket 30. Accordingly, each of the first and second support brackets 28, 30 may be operably coupled to the vehicle floor 18 to secure the vehicle seating assembly 10 within the interior compartment 50 of the vehicle 12.

Each of the first and second support brackets 28, 30 include a front portion 90 having a front edge 92 defining a receiving surface 94 positioned proximate a vehicle-forward position and a rear portion 96 having a rear edge 98 positioned proximate a vehicle-rearward position. The receiving surface 94 of each of the first and second support brackets 28, 30 is configured to receive the first and second lift brackets 36, 38, as is further described herein. Additionally, the front portion 90 of each of the first and second support brackets 28, 30 define a slot 110 configured to receive the biasing member 40 of the first and second lift brackets 36, 38.

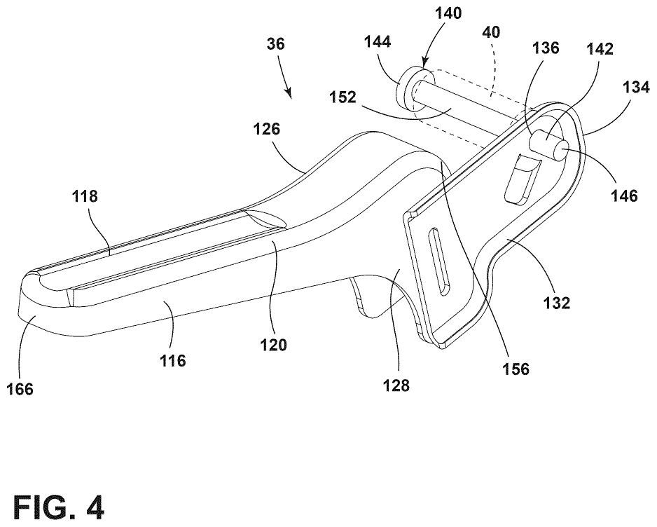

Referring now to the embodiment generally illustrated in FIGS. 4-6, the first and second lift brackets 36, 38, when used in conjunction with the vehicle seating assembly 10, generally define the lift assist and support assembly 26 configured to provide structural support to the vehicle seating assembly 10. It will be noted that the first lift bracket 36, or left lift bracket 36, is a mirror image of the second lift bracket 38, or right lift bracket 38. For purposes of clarity, either one of the left or right lift brackets 36, 38 may be discussed in detail below. However, one having ordinary skill in the art will understand that the left lift bracket 36 is a mirror image of the right lift bracket 38, and that all features and functions of the left lift bracket 36 are identical to the right lift bracket 38.

The first and second lift brackets 36, 38 include an elongate body 116 defining a groove 118 at a top surface 120 of the body 116 configured to receive a portion of the seat base frame 74. The body 116 of the first and second lift brackets 36, 38 includes an external side 126 and an internal side 128. A portion of a pivot bracket 132 is coupled to the internal side 128 of the body 116 of the first and second lift brackets 36, 38 and may be coupled to the first and second lift brackets 36, 38 via welding, mechanical fasteners, and other contemplated coupling mechanisms. A free end 134 of the pivot bracket 132 that is not coupled to the first and second lift brackets 36, 38 may define an aperture 136 configured to receive a pivot pin 140. Accordingly, the aperture 136 defined by the pivot bracket 132 aligns with the slot 110 defined by each of the first and second support brackets 28, 30. The pivot pin 140 includes a shaft 142 with a head portion 144 on one end 146a and an opposing free end 146b. When the aperture 136 of the pivot bracket 132 and the slot 110 of the first and second support brackets 28, 30 are aligned, the free end 146b of the shaft 142 extends through the slot 110 and the aperture 136 to assist in coupling the lift members to the first and second support brackets 28, 30.

Additionally, the biasing member 40 may encompass the shaft 142 of the pivot pin 140. The biasing member 40 may define a channel 152 configured to receive the shaft 142 of the pivot pin 140. Accordingly, the biasing member 40 may be positioned between the free end 134 of the pivot bracket 132 proximate the aperture 136 and the slot 110 of the side member when the first and second lift brackets 36, 38 are operably coupled with each of the first and second support brackets 28, 30. It is contemplated that the biasing member 40 may be a clockspring, torsion spring, compression spring, Belleville Spring, elastomeric bushing, gas spring, or pneumatic cylinder amongst various other biasing members 40. Accordingly, when the first and second lift brackets 36, 38 are engaged with each of the first and second support brackets 28,30, the first and second lift brackets 36, 38 are operable between a first position, which is a generally vertical position relative to the vehicle floor 18, in which the first position corresponds with the stowed position of the seat base 14 and a second position, which is a generally horizontal position relative to the vehicle floor 18, in which the second position corresponds with the deployed position of the seat base 14.

Referring still to FIGS. 4-6, during manufacturing, each of a rearward end 156 of the first and second lift brackets 36, 38 engages with the receiving surface 94 of each of the first and second support brackets 28, 30, respectively. Accordingly, the pivot bracket 132 of each of the first and second lift members is positioned proximate an interior 160 of the first and second support brackets 28, 30 such that the aperture 136 defined by the pivot bracket 132 aligns with the slot 110 defined by each of the first and second support brackets 28, 30. The free end 146b of the shaft 142 is extended through the slot 110 and the aperture 136 such that the head portion 144 of the pivot pin 140 is positioned on an exterior 162 of the first and second support brackets 28, 30. Additionally, the channel 152 of the biasing member 40 may align with the aperture 136 defined by the pivot bracket 132 and the slot 110 defined by each of the first and second support brackets 28, 30. The free end 146b of the shaft 142 of the pivot pin 140 may then be received by the slot 110 of the first and second support brackets 28, 30 extending through the channel 152 of the biasing member 40 and the aperture 136 of the pivot bracket 132. Accordingly, the biasing member 40 may encompass the shaft 142 of the pivot pin 140 when engaged with the first and second support brackets 28, 30 and the first and second lift brackets 36, 38.

When the first and second lift brackets 36, 38 are operably coupled to the first and second support brackets 28, 30 of the vehicle seating assembly 10, the groove 118 of each of the first and second lift brackets 36, 38 may receive the side beams 82a, 82b of the seat base frame 74. In particular, the opposing side beams 82a, 82b of the seat base frame 74 may rest on the groove 118 of each of the first and second lift brackets 36, 38 such that a front end 166 of the first and second lift brackets 36, 38 is positioned proximate the front beam 80 of the seat base frame 74. The groove 118 defined by each of the first and second lift brackets 36, 38 assists in providing stability and security to the seat base frame 74 and, consequently, to the seat base 14. Particularly, the grooves of the first and second lift brackets 36, 38 provide for a secure connection between the lift assembly 26 and the seat base 14 when the seat base 14 operates between the stowed position and the deployed position.

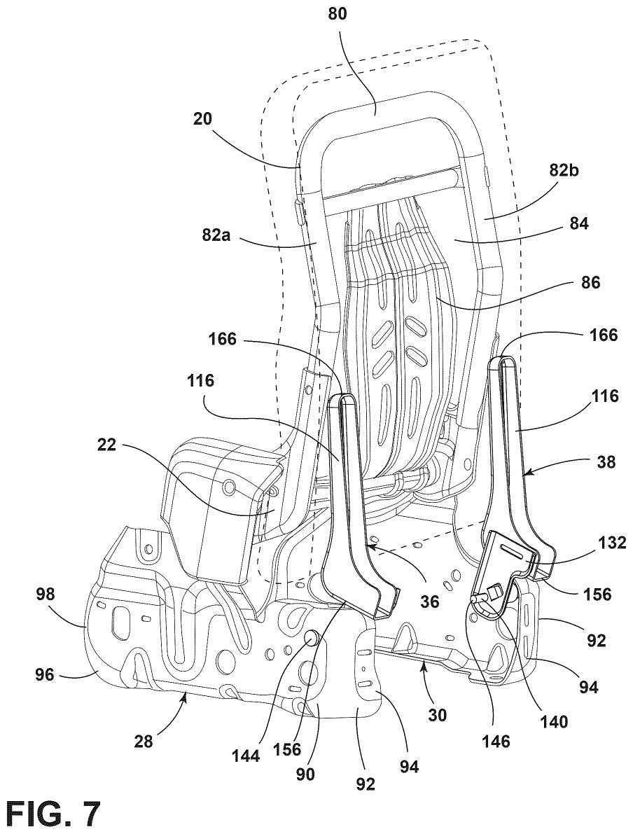

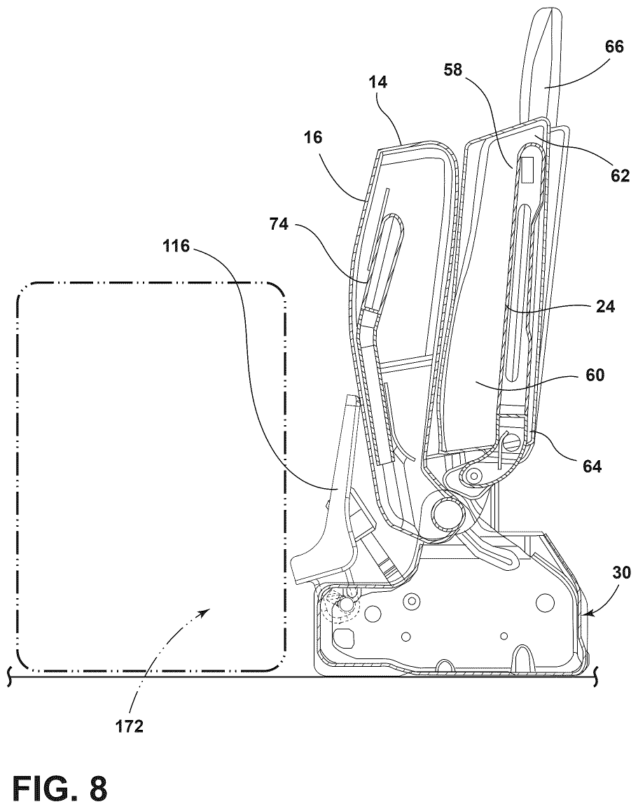

Referring to FIGS. 7 and 8, in operation, the user such as the passenger of the vehicle 12 may operate the vehicle 12 between the stowed position which may define an open area 172 between the seating assembly 10 and the vehicle floor 18. As such, the passenger may place cargo and varying storage elements in the open area 172. Additionally, the passenger may place the seating assembly 10 in the deployed position such that the passenger may be seated during vehicle 12 operation. Accordingly, when the seat base 14 operates from the deployed position to the stowed position, each of the first and second lift brackets 36, 38 may pivot about the front edge 92 of each of the first and second support brackets 28, 30 via the pivot pin 140 in a vehicle-upward direction towards the seatback 24. Each of the first and second lift brackets 36, 38 may be in the first position so that the first and second lift brackets 36, 38 are positioned vertically relative to the vehicle floor 18. The biasing member 40 may selectively bias the seat base 14 based on the position of the first and second lift brackets 36, 38. For example, the biasing member 40 may be biased towards the stowed state when the first and second lift brackets 36, 38 are in the first position. Additionally, when the first and second lift brackets 36, 38 are in the first position as the seat base 14 is in the stowed position, the grooves of the first and second lift brackets 36, 38 may be spaced apart from the opposing side portions of the seat base frame 74. In particular, the front end 166 of the first and second lift brackets 36, 38 may be in contact with the seat base frame 74 as the grooves of the first and second lift brackets 36, 38 are spaced apart from the seat base frame 74.

When the seat base 14 is adjusted by the user or passenger applying force from the stowed position to the deployed position, a biasing force may be applied to the seat base 14 to adjust the first and second lift brackets 36, 38 from the first position to the second position and, consequently, the seat base 14 from the stowed position to the deployed position. As the seat base 14 transitions to the deployed position, the first and second lift brackets 36, 38 may rotate about the front edge 92 of the first and second support brackets 28, 30 via the pivot pin 140 in a vehicle-downward direction towards the vehicle floor 18. Accordingly, the biasing member 40 may bias the first and second lift brackets 36, 38 towards the second position when the seat base 14 is in the deployed state. Additionally, as the seat base 14 transitions from the stowed position to the deployed position, the grooves of the first and second lift brackets 36, 38 may initially be spaced apart from the seat base frame 74. As the biasing force is consistently placed on the seat base 14, adjusting the seat base 14 in the vehicle-downward direction, the grooves of the first and second lift brackets 36, 38 may incrementally receive the opposing side beams 82a, 82b of the seat base frame 74. Accordingly, when the seat base 14 is in a fully deployed position, the grooves of the first and second lift brackets 36, 38 may be fully in contact with the opposing side beams 82a, 82b of the seat base frame 74 to secure the seat base 14 to the first and second lift brackets 36, 38.

As the seat base 14 transitions from the deployed state to the stowed state the open area 172 may be defined between the seat base 14 and the vehicle floor 18. The open area 172 may allow for additional storage of cargo without the interference of any additional structural components of the seat base 14 interfering with or consuming the open area 172. Accordingly, when the seat base 14 is in the stowed position, the seating assembly 10 may include a narrow, thin profile to maximize the storage capability of the open area 172. Additionally, when the seat base 14 is transitioned from the stowed position to the deployed position, the passenger may be seated thereon. During vehicular movement, a weight of the passenger may be supported by the forward portion 20 of the seat base 14. In particular, the first and second lift brackets 36, 38 including the grooves assist in securing the seat base 14 in the deployed position.

Use of the present device and system may provide for a variety of advantages. For example, the first and second lift brackets 36, 38 operably coupled to the seat base frame 74 allow for rotation about the front edge 92 of the first and second support brackets 28, 30 to assist in operating the seat base 14 between the deployed position and the seated position. As such, when the seat base 14 is in the stowed position, the seat base 14 defines a narrow profile allowing for access to the open area 172 between the seat base 14 and the vehicle floor 18. The open area 172 allows for a user to store items and cargo. Additionally, when the first and second lift brackets 36, 38 are in the second position and the seat base 14 is in the deployed position, the grooves of the first and second

lift brackets 36, 38 may receive the opposing side beams 82a, 82b of the seat base frame 74. As such, the grooves assist in securing the seat base frame 74 when the seat base 14 is in the deployed position, particularly when the passenger is seated. Additionally, the configuration of the first and second lift brackets 36, 38 operably engaged with the first and second support brackets 28, 30 assists in supporting the passenger when there is rigorous vehicular movement when the seat base 14 is in the deployed state and the passenger is seated thereon.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A vehicle seating assembly, comprising:
a seat base having an underside, wherein the seat base is operably coupled to a vehicle floor and includes a forward portion and rearward portion; and
a lift assembly operably coupled to the seat base, wherein the lift assembly operates the seat base between a stowed position and a deployed position, the lift assembly comprising:
a support bracket coupled to the rearward portion of the seat base;
a lift bracket operably coupled to the support bracket, wherein the lift bracket engages with the forward portion of the seat base; and
a biasing member operably coupled to the lift bracket, wherein the biasing member is configured to selectively bias the first and second lift brackets as the seat base adjusts between the stowed position and the deployed position.

2. The seating assembly of claim 1, wherein the lift bracket is operable between a first position when the seat base is in the stowed position and a second position when the seat base is in the deployed position.

3. The seating assembly of claim 1, wherein the support bracket defines a front edge and a rear edge, wherein the front edge defines a receiving surface and a slot.

4. The seating assembly of claim 3, wherein the lift bracket includes an elongate body having a first end and a second end, and wherein the second end of the lift bracket engages with the receiving surface when the seat base is in the deployed position.

5. The seating assembly of claim 4, wherein the lift bracket includes a pivot bracket coupled to the second end, and wherein the pivot bracket defines an aperture.

6. The seating assembly of claim 5, wherein the aperture of the pivot bracket and the slot of the support bracket align to receive a pivot pin.

7. The seating assembly of claim 6, wherein the pivot pin includes a shaft having a first end and a second end, and wherein the first end of the shaft includes a head portion and the second end of the shaft defines a free end.

8. The seating assembly of claim 7, wherein the free end of the pivot pin extends through the slot of the support bracket and the aperture of the pivot bracket when the slot and the aperture are aligned such that the head portion of the pivot pin is positioned on an exterior of the support bracket.

9. The seating assembly of claim 8, wherein the biasing member defines a channel positioned between the slot of the support bracket and the aperture of the pivot bracket such that the shaft of the pivot pin extend through the channel.

10. The seating assembly of claim 1, further comprising:
a seat base frame operably coupled to the underside of the seat base, wherein the seat base frame includes a beam assembly.

11. The seating assembly of claim 10, wherein the lift bracket includes a top surface defining a groove, and wherein the groove is configured to engage with the beam assembly of the seat base frame.

12. The seating assembly of claim 1, wherein an open area is defined between the underside of the seat base and the vehicle floor when the seat base is in the stowed position.

13. A vehicle seating assembly, comprising:
a seat base operable between a stowed position and a deployed position, wherein the seat base includes a forward portion and rearward portion; and
a support bracket operably coupled to the rearward portion of the seat base, wherein the support bracket includes a receiving surface; and
a lift bracket extending from the receiving surface of the support bracket, wherein the lift bracket is operable between a first position when the seat base is in the stowed position and a second position when the seat base is in the deployed position.

14. The vehicle seating assembly of claim 13, further comprising:
a seat base frame including opposing side beams extending from opposing ends of a front beam.

15. The vehicle seating assembly of claim 14, wherein the lift bracket defines a groove, and wherein the groove of the lift bracket is configured to receive at least one of the opposing side beams of the seat base frame.

16. The vehicle seating assembly of claim 15, wherein the groove of the lift bracket is spaced apart from at least one of the opposing side beams of the seat base frame when the lift bracket is in the first position.

17. The vehicle seating assembly of claim 13, further comprising:
a biasing member operably coupled to the lift bracket, wherein the biasing member engages with the support bracket to selectively bias the lift bracket between the first position when the seat base is in the stowed position and the second position when the seat base is in the deployed position.

18. A seating assembly for a vehicle, comprising:
a seat base having an underside operably coupled to a vehicle floor, wherein the seat base includes a forward portion and a rearward portion;
a seatback operably coupled to the rearward portion of the seat base; and
a lift assembly operably coupled to the seat base, wherein the lift assembly operates the seat base between a stowed position and a deployed position, the lift assembly includes:
a first side member and a second side member operably coupled to the rearward portion of the seat base on a first side and a second side, respectively, the second side opposite the first side;
a first lift bracket extending from the first side member and a second lift bracket extending from the second side member, wherein the first lift bracket and the second lift bracket engage with the underside of the seat base and are configured to rotate about the first side member and the second side member, respectively; and
a biasing member operably coupled to each of the first lift bracket and the second lift bracket configured to selectively bias the first and second lift brackets as the seat base adjusts between the stowed position and the deployed position.

19. The vehicle seating assembly of claim 18, wherein each of the first side member and the second side member define a slot and each of the first lift bracket and the second lift bracket define an aperture, and wherein the slot and the aperture align to receive a pivot pin.

20. The vehicle seating assembly of claim 19, wherein the pivot pin includes a head portion and a free end, and wherein the head portion of the pivot pin is positioned on an external side of each of the first and second side members and the free end of the pivot pin is positioned proximate an internal side of each of the first and second side members.
